(19) United States
(12) Patent Application Publication
(10) Pub. No.: US 2024/0154780 A1
(43) Pub. Date: May 9, 2024

(54) TIME AND FREQUENCY CONFIGURATION FOR SUB-BAND FULL-DUPLEX COMMUNICATIONS

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Abdelrahman Mohamed Ahmed Mohamed IBRAHIM, San Diego, CA (US)

(21) Appl. No.: 18/502,463

(22) Filed: Nov. 6, 2023

Related U.S. Application Data
(60) Provisional application No. 63/382,585, filed on Nov. 7, 2022.

(51) Int. Cl. H04L 5/14; H04L 5/00

(52) U.S. Cl. CPC H04L 5/14; H04L 5/0094; H04L 5/0096

(57) ABSTRACT

Various aspects of the present disclosure generally relate to wireless communication. In some aspects, a user equipment (UE) may receive information indicating a sub-band full-duplex (SBFD) frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The UE may communicate with another device using the SBFD frequency configuration. Numerous other aspects are described.

### CROSS-REFERENCE TO RELATED APPLICATION

This patent application claims priority to U.S. Provisional Patent Application No. 63/382,585, filed on Nov. 7, 2022, entitled “TIME AND FREQUENCY CONFIGURATION FOR SUB-BAND FULL-DUPLEX COMMUNICATIONS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for time and frequency configuration for sub-band full-duplex communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving information indicating a sub-band full-duplex (SBFD) frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The method may include communicating with another device using the SBFD frequency configuration.

Some aspects described herein relate to a method of wireless communication performed by a network node. The method may include transmitting information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The method may include communicating with another device using the SBFD frequency configuration.

Some aspects described herein relate to a UE for wireless communication. The UE may include one or more memories and one or more processors coupled to the one or more memories. The one or more processors may be configured to receive information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The one or more processors may be configured to communicate with another device using the SBFD frequency configuration.

Some aspects described herein relate to a network node for wireless communication. The network node may include one or more memories and one or more processors coupled to the one or more memories. The one or more processors may be configured to transmit information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The one or more processors may be configured to communicate with another device using the SBFD frequency configuration.

Some aspects described herein relate to a non-transitory computer-readable medium that stores a set of instructions for wireless communication by a UE. The set of instructions, when executed by one or more processors of the UE, may cause the UE to receive information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The set of instructions, when executed by one or more processors of the UE, may cause the UE to communicate with another device using the SBFD frequency configuration.

Some aspects described herein relate to a non-transitory computer-readable medium that stores a set of instructions for wireless communication by a network node. The set of instructions, when executed by one or more processors of the network node, may cause the network node to transmit information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The set of instructions, when executed by one or more processors of the network node, may cause the network node to communicate with another device using the SBFD frequency configuration.

Some aspects described herein relate to an apparatus for wireless communication. The apparatus may include means for receiving information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The apparatus may include means for communicating with another device using the SBFD frequency configuration.

Some aspects described herein relate to an apparatus for wireless communication. The apparatus may include means for transmitting information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The apparatus may include means for communicating with another device using the SBFD frequency configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a slot format, in accordance with the present disclosure.

FIG. 5 is a diagram illustrating examples of full-duplex communication in a wireless network, in accordance with the present disclosure.

FIG. 6 is a diagram illustrating an example associated with resource allocation scaling for sub-band full-duplex (SBFD) communications, in accordance with the present disclosure.

FIG. 7 is a diagram illustrating an example associated with an SBFD frequency configuration, in accordance with the present disclosure.

FIG. 8 is a diagram illustrating another example associated with an SBFD frequency configuration, in accordance with the present disclosure.

FIGS. 9A and 9B are diagrams illustrating an examples associated with various SBFD frequency configurations, in accordance with the present disclosure.

FIG. 10 is a diagram illustrating examples associated with various SBFD timing configurations, in accordance with the present disclosure.

FIG. 11 is a diagram illustrating an example process performed, for example, by a UE, in accordance with the present disclosure.

FIG. 12 is a diagram illustrating an example process performed, for example, by a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

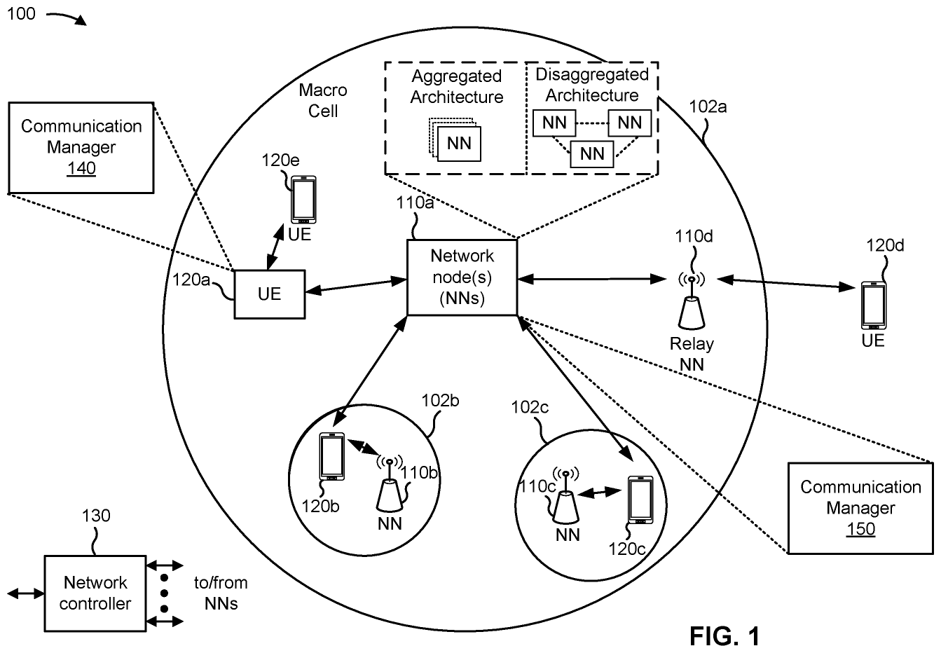

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive information indicating a sub-band full-duplex (SBFD) frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol; and communicate with another device using the SBFD frequency configuration. Additionally, or alternatively, the communication manager 140 may perform one or more other operations described herein.

In some aspects, the network node 110 may include a communication manager 150. As described in more detail elsewhere herein, the communication manager 150 may transmit information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol; and communicate with another device using the SBFD frequency configuration. Additionally, or alternatively, the communication manager 150 may perform one or more other operations described herein.

As indicated above, FIG. 1 is provided as an example. Other examples may differ from what is described with regard to FIG. 1.

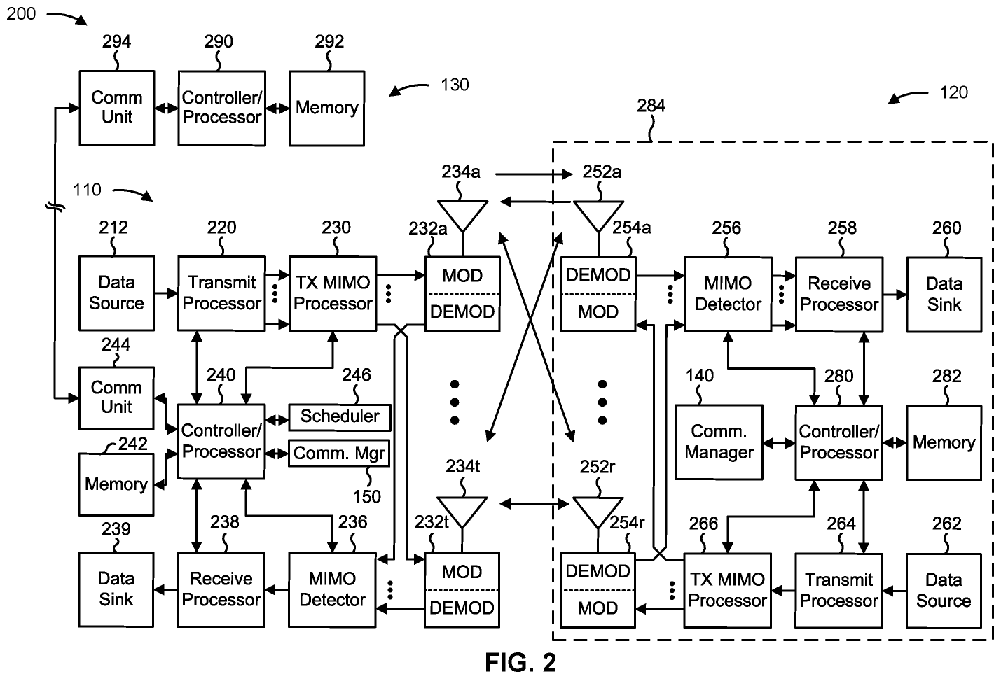

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

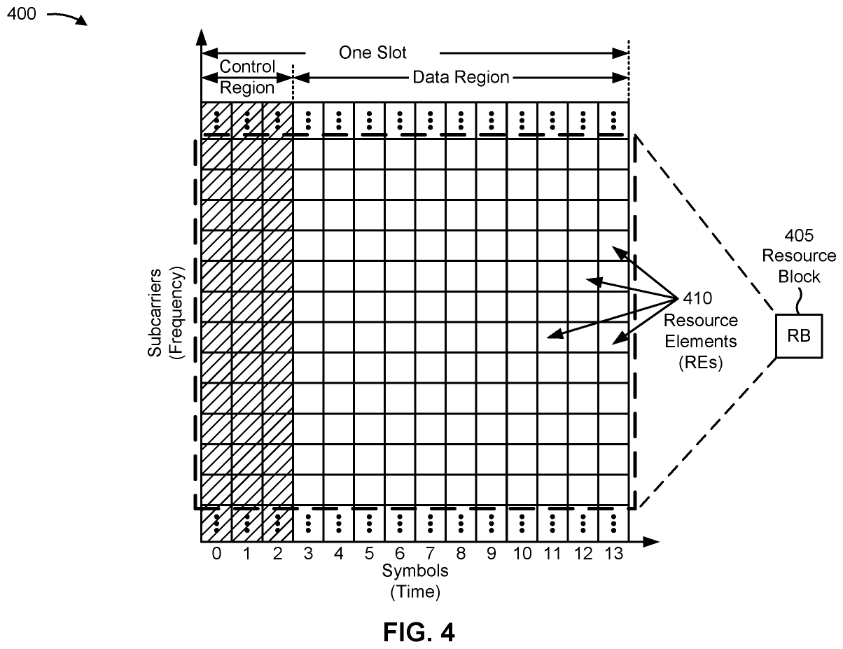

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-14).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-14).

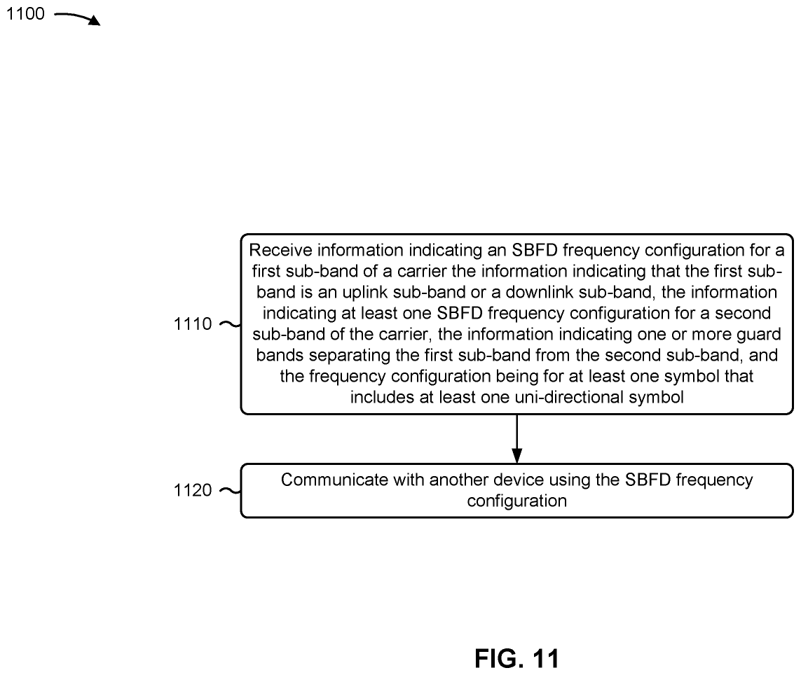

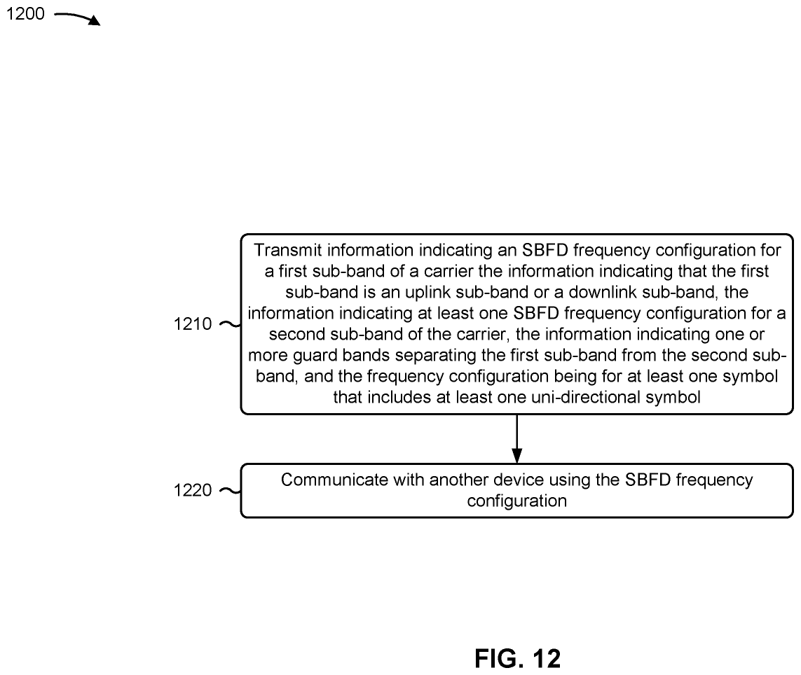

The controller/processor 240 of the network node 110, the controller/processor 280 of the UE 120, and/or any other component(s) of FIG. 2 may perform one or more techniques associated with time and frequency configuration for sub-band full-duplex communications, as described in more detail elsewhere herein. For example, the controller/processor 240 of the network node 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

In some aspects, the UE includes means for receiving information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol; and/or means for communicating with another device using the SBFD frequency configuration. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol; and/or means for communicating with another device using the SBFD frequency configuration. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

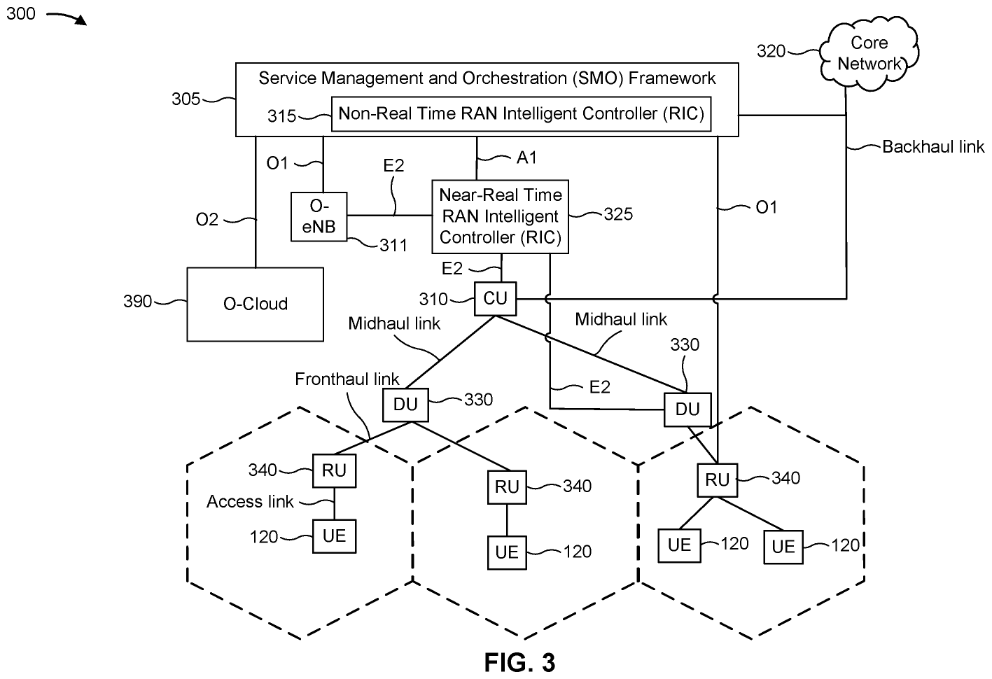

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of a slot format, in accordance with the present disclosure. As shown in FIG. 4, time-frequency resources in a radio access network may be partitioned into resource blocks, shown by a single resource block (RB) 405. An RB 405 is sometimes referred to as a physical resource block (PRB). An RB 405 includes a set of subcarriers (e.g., 12 subcarriers) and a set of symbols (e.g., 14 symbols) that are schedulable by a network node 110 as a unit. In some aspects, an RB 405 may include a set of subcarriers in a single slot. As shown, a single time-frequency resource included in an RB 405 may be referred to as a resource element (RE) 410. An RE 410 may include a single subcarrier (e.g., in frequency) and a single symbol (e.g., in time). A symbol may be referred to as an orthogonal frequency division multiplexing (OFDM) symbol. An RE 410 may be used to transmit one modulated symbol, which may be a real value or a complex value. In some aspects, RBs may be bundled together to form resource block groups (RBGs). For example, and as described further herein, an RBG may include multiple RBs, such as 2, 4, 8, or 16 RBs, which are allocated for wireless communication.

In some telecommunication systems (e.g., NR), RBs 405 may span 12 subcarriers with a subcarrier spacing of, for example, 15 kilohertz (kHz), 30 kHz, 60 kHz, or 120 kHz, among other examples, over a 0.1 millisecond (ms) duration. A radio frame may include 40 slots and may have a length of 10 ms. Consequently, each slot may have a length of 0.25 ms. However, a slot length may vary depending on a numerology used to communicate (e.g., a subcarrier spacing and/or a cyclic prefix format). A slot may be configured with a link direction (e.g., downlink or uplink) for transmission. In some aspects, the link direction for a slot may be dynamically configured.

As indicated above, FIG. 4 is provided as an example. Other examples may differ from what is described with respect to FIG. 4.

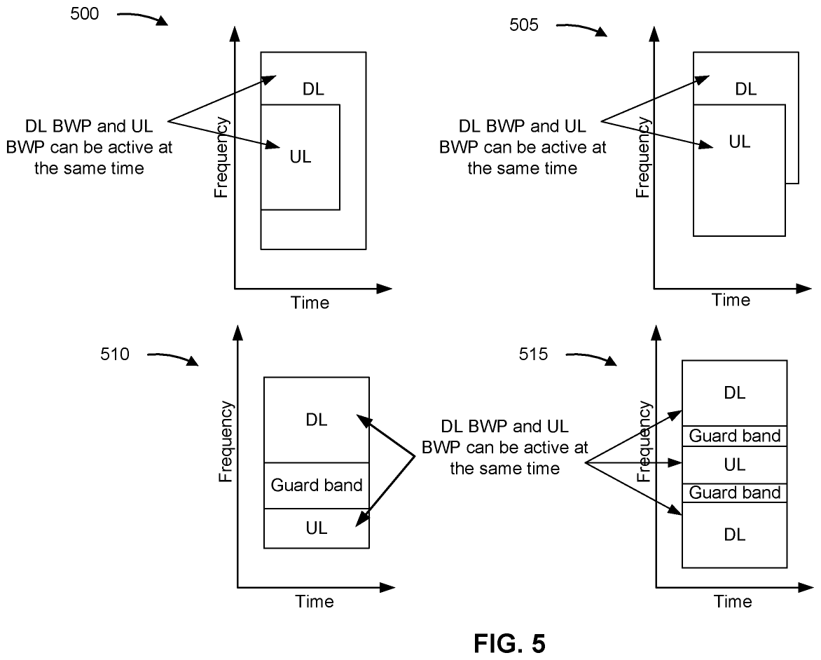

FIG. 5 is a diagram illustrating examples 500, 505, 510, and 515 of full-duplex communication in a wireless network, in accordance with the present disclosure. “Full-duplex communication” in a wireless network refers to simultaneous bi-directional communication between devices in the wireless network. For example, a UE or network node operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol). Half-duplex communication may be performed, for example, using frequency division duplexing (FDD) and/or time-division duplexing (TDD). In FDD mode, for example, a UE may use a first frequency region (or channel) of a carrier (e.g., frequency band, layer, region, or range, for communications) for uplink communication and a second frequency region (or channel) of the carrier for downlink communication at the same time (e.g., in a same frame, slot, and/or symbol). In TDD mode, a UE may transmit uplink communications and receive downlink communications in a single carrier, or frequency region, but at different time intervals (e.g., frames, slots, and/or symbols).

As shown in FIG. 5, examples 500 and 505 show examples of in-band full-duplex (IBFD) communication. In IBFD, a UE may transmit an uplink communication to a network node and receive a downlink communication from the network node on the same time and frequency resources. As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

As further shown in FIG. 5, examples 510 and 515 show examples of SBFD communications, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a carrier, such as a time division duplexing band. In this case, the frequency resources used for downlink communication may be separated from the frequency resources used for uplink communication, in the frequency domain, by one or more guard bands.

While SBFD communications may be dynamically configured (e.g., via downlink control information or radio resource control) and enable more flexible communications between wireless devices, there is currently no mechanism for semi-static SBFD configuration. Without semi-static configuration, dynamic SBFD configurations require periodic configuration that may introduce periodic networking and processing overhead to configure and enable SBFD communications.

As indicated above, FIG. 5 is provided as an example. Other examples may differ from what is described with respect to FIG. 5.

Some techniques and apparatuses described herein enable flexible (e.g., dynamic and/or semi-static) SBFD configuration of time and frequency resources. For example, a network node may transmit, to a UE, information indicating an SBFD frequency configuration for a first sub-band of a carrier. The information may explicitly indicate a whether the first sub-band is for uplink or downlink communications, and explicitly or implicitly indicate other frequency allocations for another sub-band and one or more guard bands. The SBFD configuration may enable the UE and network node to communicate bi-directionally (e.g., both uplink and downlink) with one another using frequency resources that are otherwise indicated as uni-directional frequency resources for non-SBFD communications (e.g., uplink or downlink resources). The information may be provided via one or more information elements included in a system information broadcast and/or RRC communication, enabling SBFD configuration whether the UE is RRC-connected or otherwise. In some aspects, the information may also indicate a timing configuration that indicates time resources, periodicity, and/or the like, to enable semi-static SBFD configuration. In this way, devices may be dynamically and/or semi-statically configured to communicate with one another using an SBFD configuration that provides more flexible communication resources than a non-SBFD configuration. In addition, the SBFD configuration may only be used by SBFD-capable UEs, such that non-SBFD UEs are still able to communicate using the same resources (e.g., using the same TDD configuration but uni-directional frequency allocations instead of SBFD frequency allocations). As a result, signaling overhead for SBFD configuration may be reduced, relative to dynamic SBFD configuration, which may reduce processing and communication resource usage by devices using SBFD communications. The SBFD communications may also enable more efficient network resource usage and improve latency and throughput in situations where network communications might otherwise be delayed or throttled by more limited uni-directional allocations.

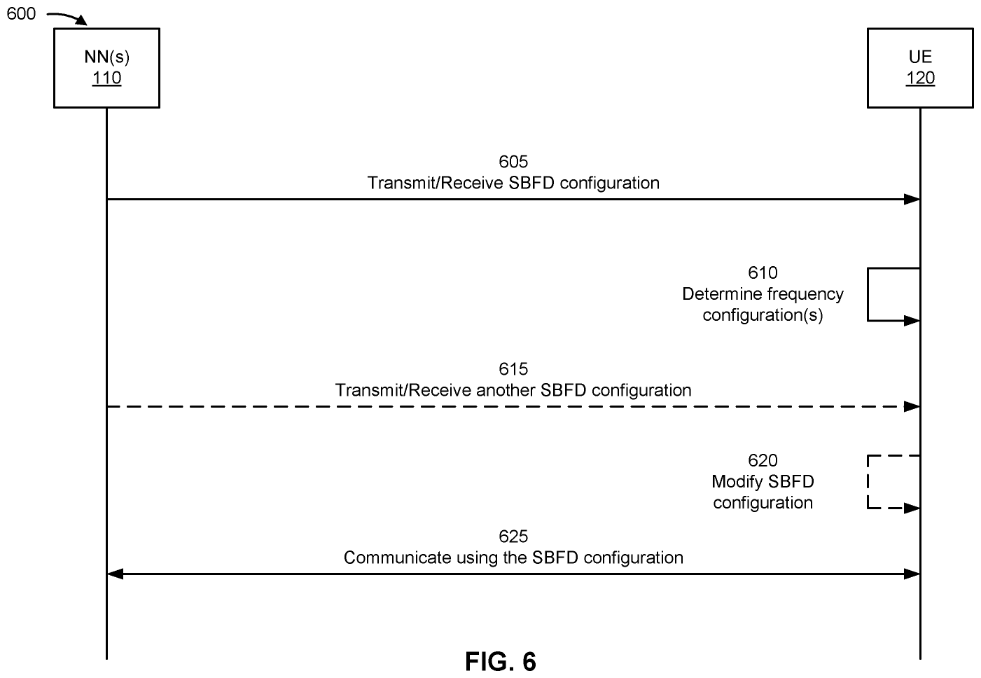

FIG. 6 is a diagram illustrating an example 600 associated with resource allocation scaling for SBFD communications, in accordance with the present disclosure. As shown in FIG. 6, a network node (e.g., network node 110) and a UE (e.g., UE 120) may communicate with one another. In some aspects, the network node and UE may have established communications prior to example 600. For example, the network node and UE may have established an access link. In this example, the UE may be a UE capable of SBFD communications, as described herein.

As shown by reference number 605, the network node may transmit, and the UE may receive, information indicating an SBFD frequency configuration for a first sub-band of a carrier. In some aspects, the network node may broadcast the information via one or more information elements included in a system information block (SIB), such as SIB1. For example, a broadcasted SIB1 may be received by the UE whether or not the UE has established an access link with the network node. In some aspects, the network node may transmit the information to the UE via one or more information elements included in an RRC cell common configuration communication. For example, in a situation where the UE and network node have established an access link, the UE may transmit, and the network node receive, an indication of the UE's capability of operating in SBFD symbols. Based at least in part on the indication, the network node may transmit, and the UE may receive, an RRC cell common configuration communication, which may be used to directly communicate the SBFD frequency and time configuration to the UE.

The information indicating the SBFD frequency configuration may include and/or otherwise indicate—implicitly and/or explicitly—various information regarding the SBFD frequency configuration. For example, the information may explicitly indicate whether the first sub-band is an uplink sub-band or a downlink sub-band. The SBFD frequency configuration may also be for at least one symbol that includes at least one uni-directional symbol (e.g., an uplink or downlink symbol) or at least one flexible symbol (e.g., a symbol that can be dynamically indicated as either an uplink symbol or downlink symbol). For example, the SBFD frequency configuration may indicate one or more downlink sub-bands for an uplink symbol and/or one or more uplink sub-bands for a downlink symbol. In addition, the information may explicitly indicate the frequency range, or ranges, configured for the first sub-band within the component carrier frequency grid. For example, the information may include a resource indicator value (RIV) that specifies a starting RB and a length (in RBs) for the first sub-band. The RIV value may be based on a maximum value of the sub-band, e.g., 273 RBs. In a situation where the first sub-band is split into separate frequency ranges, additional RIVs may be included in the information to specify other frequency ranges of the first sub-band. In some aspects, an RB offset may be determined to be a first resource block of the carrier, or determined with reference to a preconfigured reference point, such as a point A that references a particular common RB in a frequency range that includes multiple carriers, or the reference point may refer to the first RB in the component carrier, or the reference point may refer to a common resource block #0. In addition, the RB offset may be determined to have a sub-carrier spacing that is the same as that of the carrier or an explicitly configured sub-carrier spacing for the sub-band.

In some aspects, the information may indicate at least one SBFD frequency configuration for a second sub-band of the carrier. For example, the information may include an information element that explicitly identifies, using an RIV or a similar indicator, the frequency allocation of the second sub-band. As another example, the information may not explicitly identify the SBFD frequency configuration for the second sub-band, and instead the UE may implicitly determine the SBFD frequency configuration for the second sub-band based on the information. For example, given the explicit indication for the SBFD frequency configuration for the first sub-band and an explicit indication of (or predetermined) one or more guard bands (described further herein), the UE may determine the SBFD frequency configuration for the second sub-band to include portions of the carrier that are not included in the first sub-band and the one or more guard bands. The second sub-band may be opposite the first sub-band. For example, if the first sub-band is an uplink sub-band, the second sub-band may be a downlink sub-band.

In some aspects, the information may indicate one or more guard bands separating the first sub-band from the second sub-band. For example, the information may include an information element that explicitly identifies, using an RIV or a similar indicator, the frequency allocation of one or more guard bands. A single guard band may be used, for example, when the first sub-band is at an edge of the frequency range for the carrier. Multiple guard bands may be used, for example, when the first sub-band is between two portions of the second sub-band (e.g., as seen in example 515 of FIG. 5). In some aspects, the information may not explicitly identify the one or more guard bands, and instead the UE may implicitly determine the one or more guard bands based on the information. For example, given the explicit indication for the SBFD frequency configuration for the first sub-band and an explicit indication of the SBFD frequency configuration for the second sub-band, the UE may determine the one or more guard bands to include portions of the carrier that are not included in the portions identified for the first and second SBFD frequency configurations.

In some aspects, the information indicating the SBFD frequency configuration includes a first timing configuration for the first sub-band. For example, the information (e.g., SIB1 or RRC cell common communication) may include one or more information elements indicating the first timing configuration. In some aspects, the first timing configuration may indicate a time offset, a length of time, and a periodicity for the SBFD frequency configuration. In other words, the first timing configuration may indicate when the SBFD frequency configuration should begin, how long the SBFD frequency configuration should be applied, and a periodicity for repeating the SBFD configuration. In some aspects, the first timing configuration may include a bitmap indicating slots, mini-slots, and/or symbols to which the SBFD frequency configuration applies. The bitmap may enable non-contiguous SBFD symbols and/or may be associated with a periodicity for repeating the SBFD frequency configuration. In some aspects, in addition to the first timing configuration, the information may indicate a second timing configuration for the second sub-band. In a situation where no timing configuration is indicated for the second sub-band, the UE may assume no second sub-band configuration.

In some aspects, the first timing configuration is based at least in part on a TDD pattern and TDD pattern periodicity. For example, a TDD pattern may indicate, for multiple slots, which slots are uplink slots, which slots are downlink slots, and which slots are flexible slots. The TDD periodicity may indicate how often the TDD pattern repeats. The first timing configuration may indicate which slots, mini-slots, or symbols, of the TDD configuration are configured for SBFD communications. In some aspects, multiple timing patterns may be indicated, where a first timing pattern indicates the time location of the uplink sub-band within one or more of the downlink and/or flexible symbols of the TDD pattern(s), and a second timing pattern indicates the time location of the downlink sub-band within one or more of the uplink and/or flexible symbols of the TDD pattern(s). For example, the first timing configuration may indicate one or more SBFD symbol patterns with indicated uplink sub-bands (which may include mini-slot and/or symbol patterns) that indicate which portions of the TDD pattern are to be configured for SBFD communications. In a situation where multiple TDD patterns are configured, there may be one or multiple timing configurations for SBFD communications (e.g., one timing configuration for each TDD pattern). The subcarrier spacing (SCS) used for determining slot length may be based on the TDD pattern(s) or explicitly configured.

As shown by reference number 610, the UE may determine one or more frequency configurations based at least in part on the information. For example, as described herein, the UE may determine a frequency configuration for the one or more guard bands to include portions of the carrier that are not included in the first sub-band and the second sub-band. As another example, the UE may determine at least one SBFD frequency configuration for the second sub-band to include portions of the carrier that are not included in the first sub-band and the one or more guard bands.

As shown by reference number 615, in some aspects, the network node may transmit, and the UE may receive, another SBFD configuration. For example, the other SBFD configuration may be received in the same manner as the SBFD frequency configuration (e.g., both received via SIB1 or RRC cell common communication), or in a different manner (e.g., one received via SIB1 and the other received via RRC cell common communication) and may include both a time and frequency configuration for the SBFD.

As shown by reference number 620, after RRC connection, the UE may receive another indication of the cell common SBFD configuration, the UE may modify the SBFD frequency configuration and/or the first timing configuration. In some aspects, the UE may indicate, as part of its capability, a required guard band for communicating with SBFD, and the network node may indicate, to the UE, an updated indication of a new guard band between the two sub-bands. In some implementations, where the UE receives the other SBFD configuration, the UE may handle the other SBFD configuration in a variety of ways, as described herein. In some aspects, the UE may add or remove symbols from the SBFD frequency configuration. For example, if the other SBFD configuration includes additional symbols not included in the first timing configuration, the additional symbols may be added to the SBFD configuration for the UE. As another example, if the other SBFD configuration includes fewer symbols than are included in the first timing configuration, the missing symbols may be removed from the SBFD configuration. In some aspects, the other SBFD configuration may replace the SBFD frequency configuration and timing configuration. For example, if the SBFD frequency configuration and first timing configuration were configured by SIB1 broadcast, and the other SBFD configuration was received via RRC cell common communication, the UE may use the other SBFD configuration. In some aspects, the UE may disregard, or ignore, the other SBFD configuration if the SBFD configuration already exists. For example, based at least in part on the SBFD configuration and first timing configuration being configured via RRC, the UE may disregard the other SBFD configuration received via SIB1.

In some aspects, the semi-static configuration (e.g., cell-common RRC) may indicate multiple candidates of time and/or frequency SBFD configurations (e.g. represented by a table), such that the network may dynamically indicate to the UE to switch from one configuration to another. One table may be used to jointly indicate the different candidate values of the time and frequency locations of the first sub-band, or different tables (one for frequency configuration and another one for the time locations) may be used. An example table is provided here:

| | First sub-band frequency | |
|---|---|---|
| Code point | configuration | First sub-band time locations |
| 00 | RIV1 | Time-pattern1 |
| 01 | RIV2 | Time-pattern2 |
| 10 | RIV2 | Time-pattern3 |
| 11 | RIV3 | Time-pattern4 |

As shown by reference number 625, the UE may communicate using the SBFD frequency configuration, which may include communicating using the SBFD frequency configuration for the second sub-band, the one or more guard bands, the first timing configuration, and/or the second timing configuration. For example, the UE may use the SBFD frequency and timing configurations to perform SBFD communications at the configured RBs and in the configured slots, mini-slots, and/or symbols.

In this way, devices may be dynamically and/or semi-statically configured to communicate with one another using an SBFD configuration that provides more flexible communication resources than a non-SBFD configuration. In addition, the SBFD configuration may only be used by SBFD-capable UEs or SBFD-aware half-duplex UEs, such that non-SBFD UEs are still able to communicate using the same resources (e.g., using the same TDD configuration but uni-directional frequency allocations instead of SBFD frequency allocations). As a result, signaling overhead for SBFD configuration may be reduced, relative to dynamic SBFD configuration, which may reduce processing and communication resource usage by devices using SBFD communications. The SBFD communications may also enable more efficient network resource usage and improve latency and throughput in situations where network communications might otherwise be delayed or throttled by more limited uni-directional allocations.

As indicated above, FIG. 6 is provided as an example. Other examples may differ from what is described with respect to FIG. 6.

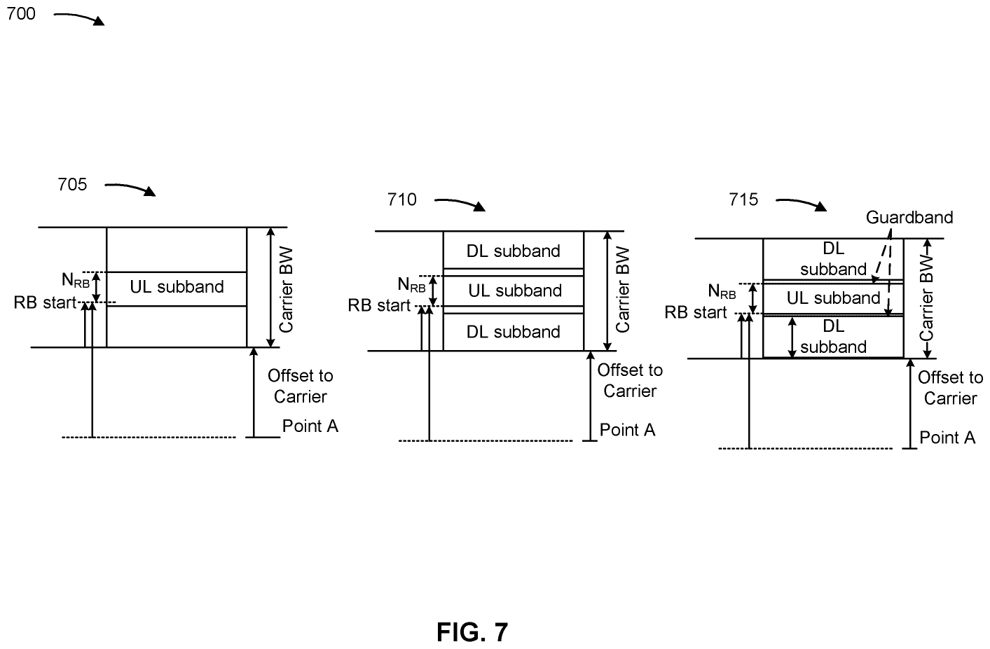

FIG. 7 is a diagram illustrating an example 700 associated with an SBFD frequency configuration, in accordance with the present disclosure. As shown in FIG. 7, an SBFD frequency configuration may be determined based on information indicating the SBFD frequency configuration.

As shown by reference number 705, the frequency of an uplink sub-band may be determined by an RB offset (e.g., offset to carrier from point A or offset with respect to first RB usable in the carrier), an RB starting value, and a number of RBs (e.g., NRB). As shown by reference number 710, the frequency ranges for the downlink sub-band may be determined. In this example, the frequency ranges may be explicitly identified (e.g., in a similar manner to the first sub-band). As shown by reference number 715, the guard bands may be implicitly determined to occupy the spaces between the uplink sub-band and the downlink sub-band.

As indicated above, FIG. 7 is provided as an example. Other examples may differ from what is described with respect to FIG. 7.

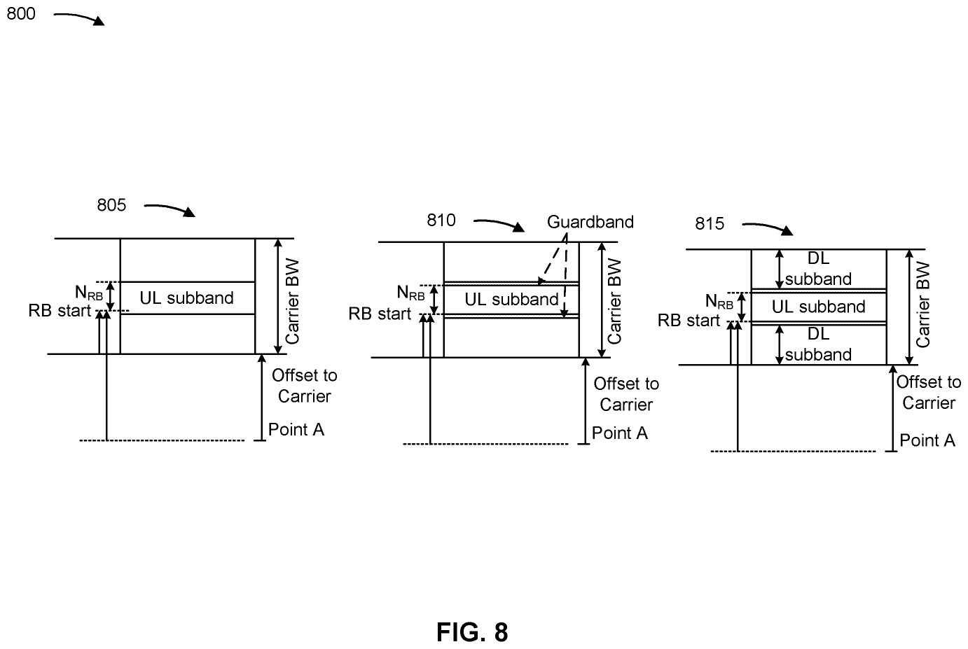

FIG. 8 is a diagram illustrating another example 800 associated with an SBFD frequency configuration, in accordance with the present disclosure. As shown in FIG. 8, an SBFD frequency configuration may be determined based on information indicating the SBFD frequency configuration.

As shown by reference number 805, the frequency of an uplink sub-band may be determined by an RB offset, an RB starting value, and a number of RBs. As shown by reference number 810, the frequency locations for the guard bands may be determined (e.g., by information explicitly indicating the guard bands). As shown by reference number 815, the downlink sub-bands may be implicitly determined to occupy the spaces within the carrier that are not occupied by the uplink sub-band and the guard bands.

As indicated above, FIG. 8 is provided as an example. Other examples may differ from what is described with respect to FIG. 8.

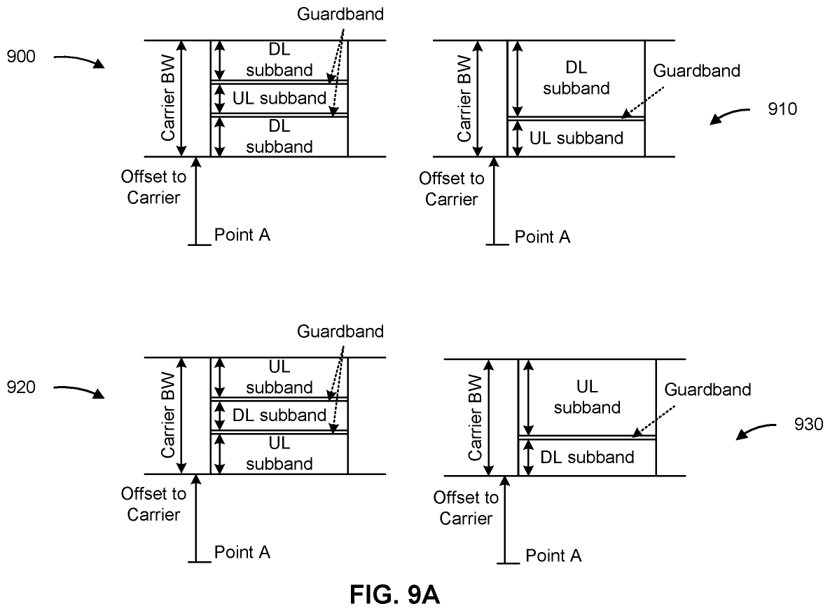

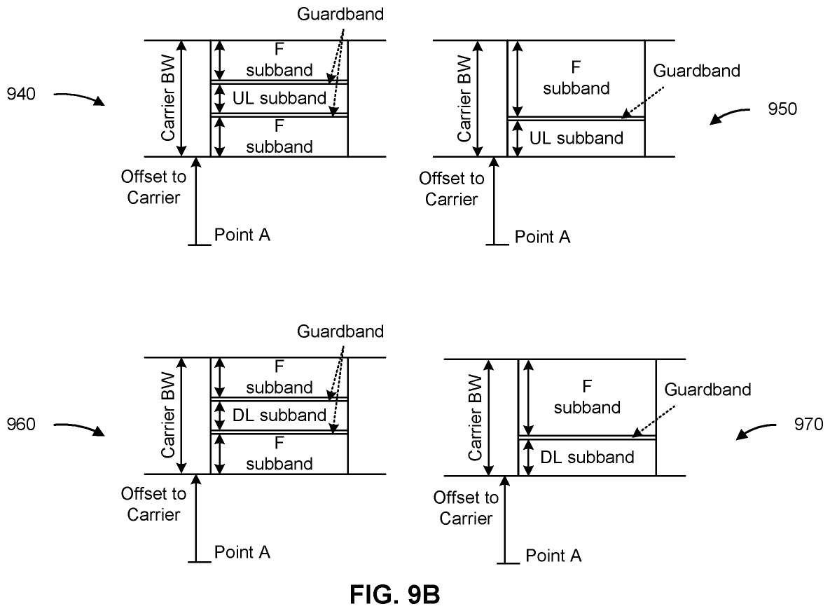

FIGS. 9A and 9B are diagrams illustrating an examples 900, 910, 920, 930, 940, 950, 960, and 970 associated with various SBFD frequency configurations, in accordance with the present disclosure.

As shown by example 900, an SBFD configuration may indicate an uplink sub-band in the middle of a downlink sub-band and separated by two guard bands.

As shown by example 910, an SBFD configuration may indicate an uplink sub-band at an edge of the carrier, separated from a downlink sub-band by a single guard band.

As shown by example 920, an SBFD configuration may indicate a downlink sub-band in the middle of an uplink sub-band and separated by two guard bands.

As shown by example 930, an SBFD configuration may indicate a downlink sub-band at an edge of the carrier, separated from the uplink sub-band by a single guard band.

As shown by example 940, an SBFD configuration may indicate an uplink sub-band in the middle of a flexible sub-band and separated by two guard bands.

As shown by example 950, an SBFD configuration may indicate an uplink sub-band at an edge of the carrier, separated from a flexible sub-band by a single guard band.

As shown by example 960, an SBFD configuration may indicate a downlink sub-band in the middle of a flexible sub-band and separated by two guard bands.

As shown by example 970, an SBFD configuration may indicate a downlink sub-band at an edge of the carrier, separated from a flexible sub-band by a single guard band.

As indicated above, FIGS. 9A and 9B are provided as examples. Other examples may differ from what is described with respect to FIGS. 9A and 9B.

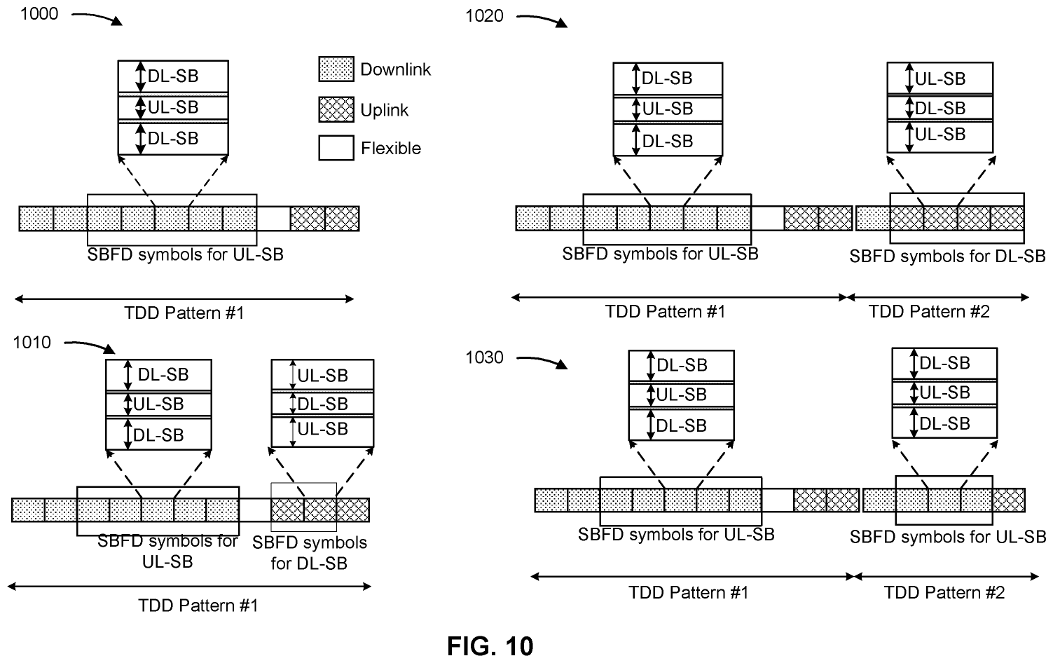

FIG. 10 is a diagram illustrating examples 1000, 1010, 1020, and 1030 associated with various SBFD timing configurations, in accordance with the present disclosure.

As shown by example 1000, an example SBFD timing configuration may span 5 downlink symbols of a TDD pattern, indicating that the 5 downlink symbols are to be treated as SBFD symbols (e.g., with an uplink sub-band and two downlink sub-bands configured).

As shown by example 1010, an example SBFD timing configuration may span two sets of symbols of a TDD pattern, indicating that 5 downlink symbols and two uplink symbols are to be treated as SBFD symbols.

As shown by example 1020, an example SBFD timing configuration may span 5 downlink symbols of a first TDD pattern and 4 uplink symbols of a second TDD pattern, indicating that the 5 downlink symbols are to be treated as SBFD symbols (e.g., with an uplink sub-band and two downlink sub-bands configured) for the first TDD pattern and the 4 uplink symbols are to be treated as SBFD symbols (e.g., with two uplink sub-bands and one downlink sub-band configured) for the second TDD pattern.

As shown by example 1030, an example SBFD timing configuration may span 5 downlink symbols of a first TDD pattern and 3 downlink symbols of a second TDD pattern, indicating that the 5 downlink symbols are to be treated as SBFD symbols for the first TDD pattern and the 3 downlink symbols are to be treated as SBFD symbols for the second TDD pattern.

As indicated above, FIG. 10 is provided as an example. Other examples may differ from what is described with respect to FIG. 10.

FIG. 11 is a diagram illustrating an example process 1100 performed, for example, by a UE, in accordance with the present disclosure. Example process 1100 is an example where the UE (e.g., UE 120) performs operations associated with time and frequency configuration for SBFD communications.

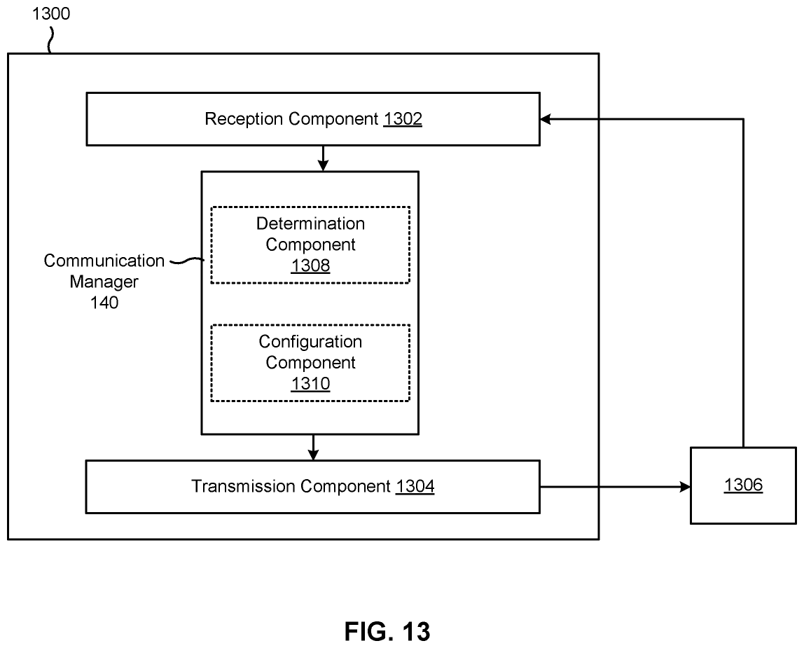

As shown in FIG. 11, in some aspects, process 1100 may include receiving information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol (block 1110). For example, the UE (e.g., using communication manager 140 and/or reception component 1302, depicted in FIG. 13) may receive information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol, as described above.

As further shown in FIG. 11, in some aspects, process 1100 may include communicating with another device using the SBFD frequency configuration (block 1120). For example, the UE (e.g., using communication manager 140, reception component 1302, and/or transmission component 1304, depicted in FIG. 13) may communicate with another device using the SBFD frequency configuration, as described above.

Process 1100 may include additional aspects, such as any single aspect or any combination of aspects described below and/or in connection with one or more other processes described elsewhere herein.

In a first aspect, receiving the information comprises receiving the information via one or more information elements included in a system information block broadcast by a network node.

In a second aspect, alone or in combination with the first aspect, receiving the information comprises receiving the information via one or more information elements included in radio resource control cell common configuration communication from a network node.

In a third aspect, alone or in combination with one or more of the first and second aspects, the first sub-band is the uplink sub-band, the second sub-band is the downlink sub-band, and the at least one uni-directional symbol comprises at least one downlink symbol.

In a fourth aspect, alone or in combination with one or more of the first through third aspects, the first sub-band is the downlink sub-band, the second sub-band is the uplink sub-band, and the at least one uni-directional symbol comprises at least one uplink symbol.

In a fifth aspect, alone or in combination with one or more of the first through fourth aspects, the information indicating the one or more guard bands includes an indication of a number of resource blocks.

In a sixth aspect, alone or in combination with one or more of the first through fifth aspects, the information indicating the one or more guard bands identifies a starting resource block and a length in resource blocks.

In a seventh aspect, alone or in combination with one or more of the first through sixth aspects, process 1100 includes determining a frequency configuration for the one or more guard bands to include portions of the carrier that are not included in the first sub-band and the second sub-band.

In an eighth aspect, alone or in combination with one or more of the first through seventh aspects, process 1100 includes determining the at least one SBFD frequency configuration for the second sub-band to include portions of the carrier that are not included in the first sub-band and the one or more guard bands.

In a ninth aspect, alone or in combination with one or more of the first through eighth aspects, the information indicating the at least one SBFD frequency configuration for the second sub-band identifies a starting resource block and a length in resource blocks.

In a tenth aspect, alone or in combination with one or more of the first through ninth aspects, the information indicating the SBFD frequency configuration for the first sub-band includes a starting resource block, a length in resource blocks, and a resource block offset.

In an eleventh aspect, alone or in combination with one or more of the first through tenth aspects, process 1100 includes determining the resource block offset with reference to one of a first resource block of the carrier, or a preconfigured reference point.

In a twelfth aspect, alone or in combination with one or more of the first through eleventh aspects, the information indicating the SBFD frequency configuration includes a first timing configuration for the first sub-band.

In a thirteenth aspect, alone or in combination with one or more of the first through twelfth aspects, the information indicating the SBFD frequency configuration includes a second timing configuration for the second sub-band.

In a fourteenth aspect, alone or in combination with one or more of the first through thirteenth aspects, the first timing configuration comprises information indicating a time offset, a length of time, and a periodicity.

In a fifteenth aspect, alone or in combination with one or more of the first through fourteenth aspects, the first timing configuration comprises information indicating a bitmap specifying SBFD symbol locations and periodicity.

In a sixteenth aspect, alone or in combination with one or more of the first through fifteenth aspects, the at least one of the first timing configuration or the second timing configuration indicates non-contiguous SBFD symbols.

In a seventeenth aspect, alone or in combination with one or more of the first through sixteenth aspects, a granularity of the bitmap is at least one of slot-based, mini-slot based, or symbol based.

In an eighteenth aspect, alone or in combination with one or more of the first through seventeenth aspects, a periodicity of the first timing configuration is based at least in part on a time domain duplexing pattern periodicity.

In a nineteenth aspect, alone or in combination with one or more of the first through eighteenth aspects, the first timing configuration indicate one or more SBFD symbol patterns.

In a twentieth aspect, alone or in combination with one or more of the first through nineteenth aspects, the first timing configuration indicates multiple SBFD symbol patterns based at least in part on multiple time domain duplexing patterns being indicated.

In a twenty-first aspect, alone or in combination with one or more of the first through twentieth aspects, a subcarrier spacing associated with the first timing configuration is based at least in part on a time domain duplexing pattern.

In a twenty-second aspect, alone or in combination with one or more of the first through twenty-first aspects, process 1100 includes receiving, via one or more information elements included in a system information block, another SBFD configuration for the first sub-band.

In a twenty-third aspect, alone or in combination with one or more of the first through twenty-second aspects, process 1100 includes adding one or more symbols to the SBFD frequency configuration based at least in part on the other SBFD configuration.

In a twenty-fourth aspect, alone or in combination with one or more of the first through twenty-third aspects, process 1100 includes removing one or more symbols from the SBFD frequency based at least in part on the other SBFD frequency configuration.

In a twenty-fifth aspect, alone or in combination with one or more of the first through twenty-fourth aspects, the at least one symbol is a flexible symbol, and one or more symbols configured for SBFD by the other SBFD configuration include one or more uplink symbols or one or more downlink symbols.

In a twenty-sixth aspect, alone or in combination with one or more of the first through twenty-fifth aspects, process 1100 includes replacing the SBFD frequency configuration with the other SBFD configuration.

In a twenty-seventh aspect, alone or in combination with one or more of the first through twenty-sixth aspects, process 1100 includes disregarding the other SBFD configuration.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a network node, in accordance with the present disclosure. Example process 1200 is an example where the network node (e.g., network node 110) performs operations associated with time and frequency configuration for SBFD communications.

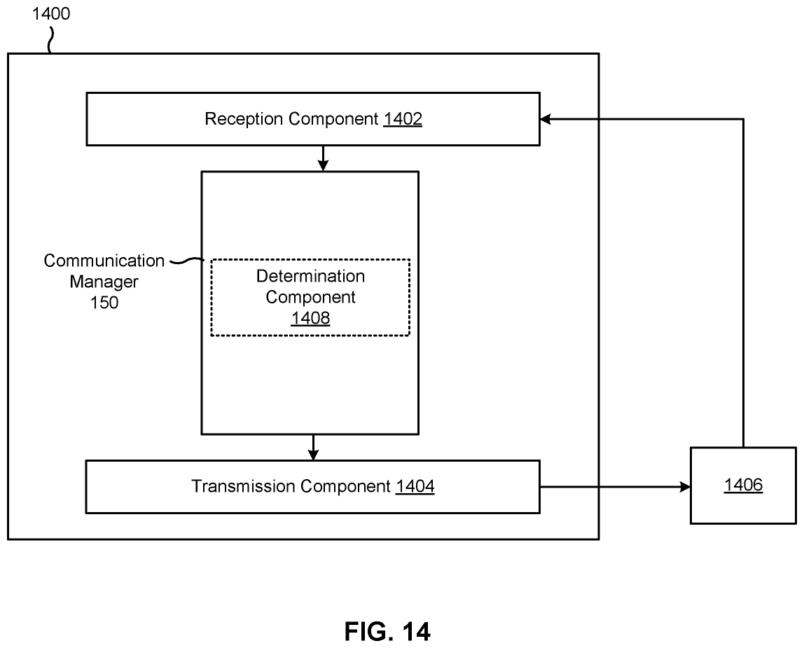

As shown in FIG. 12, in some aspects, process 1200 may include transmitting information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol (block 1210). For example, the network node (e.g., using communication manager 150 and/or transmission component 1404, depicted in FIG. 14) may transmit information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol, as described above.

As further shown in FIG. 12, in some aspects, process 1200 may include communicating with another device using the SBFD frequency configuration (block 1220). For example, the network node (e.g., using communication manager 150, reception component 1402, and/or transmission component 1404, depicted in FIG. 14) may communicate with another device using the SBFD frequency configuration, as described above.

Process 1200 may include additional aspects, such as any single aspect or any combination of aspects described below and/or in connection with one or more other processes described elsewhere herein.

In a first aspect, transmitting the information comprises broadcasting the information via one or more information elements included in a system information block.

In a second aspect, alone or in combination with the first aspect, transmitting the information comprises transmitting the information via one or more information elements included in radio resource control cell common configuration communication.

In a third aspect, alone or in combination with one or more of the first and second aspects, the first sub-band is the uplink sub-band, the second sub-band is the downlink sub-band, and the at least one uni-directional symbol comprises at least one downlink symbol.

In a fourth aspect, alone or in combination with one or more of the first through third aspects, the first sub-band is the downlink sub-band, the second sub-band is the uplink sub-band, and the at least one uni-directional symbol comprises at least one uplink symbol.

In a fifth aspect, alone or in combination with one or more of the first through fourth aspects, the information indicating the one or more guard bands includes an indication of a number of resource blocks.

In a sixth aspect, alone or in combination with one or more of the first through fifth aspects, the information indicating the one or more guard bands identifies a starting resource block and a length in resource blocks.

In a seventh aspect, alone or in combination with one or more of the first through sixth aspects, process 1200 includes determining a frequency configuration for the one or more guard bands to include portions of the carrier that are not included in the first sub-band and the second sub-band.

In an eighth aspect, alone or in combination with one or more of the first through seventh aspects, process 1200 includes determining the at least one SBFD frequency configuration for the second sub-band to include portions of the carrier that are not included in the first sub-band and the one or more guard bands.

In a ninth aspect, alone or in combination with one or more of the first through eighth aspects, the information indicating the at least one SBFD frequency configuration for the second sub-band identifies a starting resource block and a length in resource blocks.

In a tenth aspect, alone or in combination with one or more of the first through ninth aspects, the information indicating the SBFD frequency configuration for the first sub-band includes a starting resource block, a length in resource blocks, and a resource block offset.

In an eleventh aspect, alone or in combination with one or more of the first through tenth aspects, process 1200 includes determining the resource block offset with reference to one of a first resource block of the carrier, or a preconfigured reference point.

In a twelfth aspect, alone or in combination with one or more of the first through eleventh aspects, the information indicating the SBFD frequency configuration includes a first timing configuration for the first sub-band.

In a thirteenth aspect, alone or in combination with one or more of the first through twelfth aspects, the information indicating the SBFD frequency configuration includes a second timing configuration for the second sub-band.

In a fourteenth aspect, alone or in combination with one or more of the first through thirteenth aspects, the first timing configuration comprises information indicating a time offset, a length of time, and a periodicity.

In a fifteenth aspect, alone or in combination with one or more of the first through fourteenth aspects, the first timing configuration comprises information indicating a bitmap specifying SBFD symbol locations and periodicity.

In a sixteenth aspect, alone or in combination with one or more of the first through fifteenth aspects, the at least one of the first timing configuration or the second timing configuration indicates non-contiguous SBFD symbols.

In a seventeenth aspect, alone or in combination with one or more of the first through sixteenth aspects, a granularity of the bitmap is at least one of slot-based, mini-slot based, or symbol based.

In an eighteenth aspect, alone or in combination with one or more of the first through seventeenth aspects, a periodicity of the first timing configuration is based at least in part on a time domain duplexing pattern periodicity.

In a nineteenth aspect, alone or in combination with one or more of the first through eighteenth aspects, the first timing configuration indicate one or more SBFD symbol patterns.

In a twentieth aspect, alone or in combination with one or more of the first through nineteenth aspects, the first timing configuration indicates multiple SBFD symbol patterns based at least in part on multiple time domain duplexing patterns being indicated.

In a twenty-first aspect, alone or in combination with one or more of the first through twentieth aspects, a subcarrier spacing associated with the first timing configuration is based at least in part on a time domain duplexing pattern.

In a twenty-second aspect, alone or in combination with one or more of the first through twenty-first aspects, process 1200 includes broadcasting, via one or more information elements included in a system information block, another SBFD configuration for the first sub-band.

In a twenty-third aspect, alone or in combination with one or more of the first through twenty-second aspects, the other SBFD configuration indicates one or more additional symbols for the SBFD frequency configuration.

In a twenty-fourth aspect, alone or in combination with one or more of the first through twenty-third aspects, the other SBFD configuration indicates one or more symbols to be removed from the SBFD frequency configuration.

In a twenty-fifth aspect, alone or in combination with one or more of the first through twenty-fourth aspects, the at least one symbol is a flexible symbol, and one or more symbols configured for SBFD by the other SBFD configuration include one or more uplink symbols or one or more downlink symbols.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of a determination component 1308, or a configuration component 1310, among other examples.

In some aspects, the apparatus 1300 may be configured to perform one or more operations described herein in connection with FIGS. 4-10. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive information indicating an SBFD frequency configuration for a first sub-band of a carrier the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The transmission component 1304 may communicate with another device using the SBFD frequency configuration.

The determination component 1308 may determine a frequency configuration for the one or more guard bands to include portions of the carrier that are not included in the first sub-band and the second sub-band.

The determination component 1308 may determine the at least one SBFD frequency configuration for the second sub-band to include portions of the carrier that are not included in the first sub-band and the one or more guard bands.

The determination component 1308 may determine the resource block offset with reference to one of a first resource block of the carrier, or a preconfigured reference point.

The reception component 1302 may receive, via one or more information elements included in a system information block, another SBFD configuration for the first sub-band.

The configuration component 1310 may add one or more symbols to the SBFD frequency configuration based at least in part on the other SBFD configuration.

The configuration component 1310 may remove one or more symbols from the SBFD frequency based at least in part on the other SBFD frequency configuration.

The configuration component 1310 may replace the SBFD frequency configuration with the other SBFD configuration.

The configuration component 1310 may disregard the other SBFD configuration.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 150. The communication manager 150 may include a determination component 1408, among other examples.

In some aspects, the apparatus 1400 may be configured to perform one or more operations described herein in connection with FIGS. 4-10. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the network node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the network node described in connection with FIG. 2. In some aspects, the transmission component 1404 may be co-located with the reception component 1402 in a transceiver.

The transmission component 1404 may transmit information indicating an SBFD frequency configuration for a first sub-band of a carrier the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol. The transmission component 1404 may communicate with another device using the SBFD frequency configuration.

The determination component 1408 may determine a frequency configuration for the one or more guard bands to include portions of the carrier that are not included in the first sub-band and the second sub-band.

The determination component 1408 may determine the at least one SBFD frequency configuration for the second sub-band to include portions of the carrier that are not included in the first sub-band and the one or more guard bands.

The determination component 1408 may determine the resource block offset with reference to one of a first resource block of the carrier, or a preconfigured reference point.

The transmission component 1404 may broadcast, via one or more information elements included in a system information block, another SBFD configuration for the first sub-band.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a UE, comprising: receiving information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol; and communicating with another device using the SBFD frequency configuration.

Aspect 2: The method of Aspect 1, wherein receiving the information comprises: receiving the information via one or more information elements included in a system information block broadcast by a network node.

Aspect 3: The method of any of Aspects 1-2, wherein receiving the information comprises: receiving the information via one or more information elements included in radio resource control cell common configuration communication from a network node.

Aspect 4: The method of any of Aspects 1-3, wherein the first sub-band is the uplink sub-band, the second sub-band is the downlink sub-band, and the at least one uni-directional symbol comprises at least one downlink symbol.

Aspect 5: The method of any of Aspects 1-4, wherein the first sub-band is the downlink sub-band, the second sub-band is the uplink sub-band, and the at least one uni-directional symbol comprises at least one uplink symbol.

Aspect 6: The method of any of Aspects 1-5, wherein the information indicating the one or more guard bands includes an indication of a number of resource blocks.

Aspect 7: The method of any of Aspects 1-6, wherein the information indicating the one or more guard bands identifies a starting resource block and a length in resource blocks.

Aspect 8: The method of any of Aspects 1-7, further comprising: determining a frequency configuration for the one or more guard bands to include portions of the carrier that are not included in the first sub-band and the second sub-band.

Aspect 9: The method of any of Aspects 1-8, further comprising: determining the at least one SBFD frequency configuration for the second sub-band to include portions of the carrier that are not included in the first sub-band and the one or more guard bands.

Aspect 10: The method of any of Aspects 1-9, wherein the information indicating the at least one SBFD frequency configuration for the second sub-band identifies a starting resource block and a length in resource blocks.

Aspect 11: The method of any of Aspects 1-10, wherein the information indicating the SBFD frequency configuration for the first sub-band includes a starting resource block, a length in resource blocks, and a resource block offset.

Aspect 12: The method of Aspect 11, further comprising: determining the resource block offset with reference to one of: a first resource block of the carrier, or a preconfigured reference point.

Aspect 13: The method of any of Aspects 1-12, wherein the information indicating the SBFD frequency configuration includes a first timing configuration for the first sub-band.

Aspect 14: The method of Aspect 13, wherein the information indicating the SBFD frequency configuration includes a second timing configuration for the second sub-band.

Aspect 15: The method of Aspect 13, wherein the first timing configuration comprises information indicating a time offset, a length of time, and a periodicity.

Aspect 16: The method of Aspect 13, wherein the first timing configuration comprises information indicating a bitmap specifying SBFD symbol locations and periodicity.

Aspect 17: The method of Aspect 16, wherein the first timing configuration indicates non-contiguous SBFD symbols.

Aspect 18: The method of Aspect 16, wherein a granularity of the bitmap is at least one of: slot-based, mini-slot based, or symbol based.

Aspect 19: The method of Aspect 13, wherein a periodicity of the first timing configuration is based at least in part on a time domain duplexing pattern periodicity.

Aspect 20: The method of Aspect 13, wherein the first timing configuration indicate one or more SBFD symbol patterns.

Aspect 21: The method of Aspect 20, wherein the first timing configuration indicates multiple SBFD symbol patterns based at least in part on multiple time domain duplexing patterns being indicated.

Aspect 22: The method of Aspect 13, wherein the first timing configuration indicates first SBFD symbols associated with the first sub-band in at least one downlink symbol, and a second timing configuration indicates second SBFD symbols associated with the second sub-band in at least uplink symbol.

Aspect 23: The method of Aspect 13, wherein a subcarrier spacing associated with the first timing configuration is based at least in part on a time domain duplexing pattern.

Aspect 24: The method of Aspect 3, further comprising: receiving, via one or more information elements included in a system information block, another SBFD configuration for the first sub-band.

Aspect 25: The method of Aspect 24, further comprising: adding one or more symbols to the SBFD frequency configuration based at least in part on the other SBFD configuration.

Aspect 26: The method of Aspect 24, further comprising: removing one or more symbols from the SBFD frequency based at least in part on the other SBFD frequency configuration.

Aspect 27: The method of Aspect 24, wherein the at least one symbol is a flexible symbol, and one or more symbols configured for SBFD by the other SBFD configuration include one or more uplink symbols or one or more downlink symbols.

Aspect 28: The method of Aspect 24, further comprising: replacing the SBFD frequency configuration with the other SBFD configuration.

Aspect 29: The method of Aspect 28, wherein replacing the SBFD frequency configuration with the other SBFD configuration comprises: replacing a first guard band configuration with a second guard band configuration from the other SBFD configuration.

Aspect 30: The method of Aspect 24, further comprising: disregarding the other SBFD configuration.

Aspect 31: A method of wireless communication performed by a network node, comprising: transmitting information indicating an SBFD frequency configuration for a first sub-band of a carrier, the information indicating that the first sub-band is an uplink sub-band or a downlink sub-band, the information indicating at least one SBFD frequency configuration for a second sub-band of the carrier, the information indicating one or more guard bands separating the first sub-band from the second sub-band, and the frequency configuration being for at least one symbol that includes at least one uni-directional symbol; and communicating with another device using the SBFD frequency configuration.

Aspect 32: The method of Aspect 31, wherein transmitting the information comprises: broadcasting the information via one or more information elements included in a system information block.

Aspect 33: The method of any of Aspects 31-32, wherein transmitting the information comprises: transmitting the information via one or more information elements included in radio resource control cell common configuration communication.

Aspect 34: The method of any of Aspects 31-33, wherein the first sub-band is the uplink sub-band, the second sub-band is the downlink sub-band, and the at least one uni-directional symbol comprises at least one downlink symbol.

Aspect 35: The method of any of Aspects 31-34, wherein the first sub-band is the downlink sub-band, the second sub-band is the uplink sub-band, and the at least one uni-directional symbol comprises at least one uplink symbol.

Aspect 36: The method of any of Aspects 31-35, wherein the information indicating the one or more guard bands includes an indication of a number of resource blocks.

Aspect 37: The method of any of Aspects 31-36, wherein the information indicating the one or more guard bands identifies a starting resource block and a length in resource blocks.

Aspect 38: The method of any of Aspects 31-37, further comprising: determining a frequency configuration for the one or more guard bands to include portions of the carrier that are not included in the first sub-band and the second sub-band.

Aspect 39: The method of any of Aspects 31-38, further comprising: determining the at least one SBFD frequency configuration for the second sub-band to include portions of the carrier that are not included in the first sub-band and the one or more guard bands.

Aspect 40: The method of any of Aspects 31-39, wherein the information indicating the at least one SBFD frequency configuration for the second sub-band identifies a starting resource block and a length in resource blocks.

Aspect 41: The method of any of Aspects 31-40, wherein the information indicating the SBFD frequency configuration for the first sub-band includes a starting resource block, a length in resource blocks, and a resource block offset.

Aspect 42: The method of Aspect 41, further comprising: determining the resource block offset with reference to one of: a first resource block of the carrier, or a preconfigured reference point.

Aspect 43: The method of any of Aspects 31-42, wherein the information indicating the SBFD frequency configuration includes a first timing configuration for the first sub-band.

Aspect 44: The method of Aspect 43, wherein the information indicating the SBFD frequency configuration includes a second timing configuration for the second sub-band.

Aspect 45: The method of Aspect 43, wherein the first timing configuration comprises information indicating a time offset, a length of time, and a periodicity.

Aspect 46: The method of Aspect 43, wherein the first timing configuration comprises information indicating a bitmap specifying SBFD symbol locations and periodicity.

Aspect 47: The method of Aspect 46, wherein the first timing configuration indicates non-contiguous SBFD symbols.

Aspect 48: The method of Aspect 46, wherein a granularity of the bitmap is at least one of: slot-based, mini-slot based, or symbol based.

Aspect 49: The method of Aspect 43, wherein a periodicity of the first timing configuration is based at least in part on a time domain duplexing pattern periodicity.

Aspect 50: The method of Aspect 43, wherein the first timing configuration indicate one or more SBFD symbol patterns.

Aspect 51: The method of Aspect 50, wherein the first timing configuration indicates multiple SBFD symbol patterns based at least in part on multiple time domain duplexing patterns being indicated.

Aspect 52: The method of Aspect 43, wherein the first timing configuration indicates first SBFD symbols associated with the first sub-band in at least one downlink symbol, and a second timing configuration indicates second SBFD symbols associated with the second sub-band in at least uplink symbol.

Aspect 53: The method of Aspect 43, wherein a subcarrier spacing associated with the first timing configuration is based at least in part on a time domain duplexing pattern.

Aspect 54: The method of Aspect 33, further comprising: broadcasting, via one or more information elements included in a system information block, another SBFD configuration for the first sub-band.

Aspect 55: The method of Aspect 53, wherein the other SBFD configuration indicates one or more additional symbols for the SBFD frequency configuration.

Aspect 56: The method of Aspect 53, wherein the other SBFD configuration indicates one or more symbols to be removed from the SBFD frequency configuration.

Aspect 57: The method of Aspect 53, wherein the at least one symbol is a flexible symbol, and one or more symbols configured for SBFD by the other SBFD configuration include one or more uplink symbols or one or more downlink symbols.

Aspect 58: An apparatus for wireless communication at a device, comprising a processor; memory coupled with the processor; and instructions stored in the memory and executable by the processor to cause the apparatus to perform the method of one or more of Aspects 1-57.

Aspect 59: A device for wireless communication, comprising a memory and one or more processors coupled to the memory, the one or more processors configured to perform the method of one or more of Aspects 1-57.

Aspect 60: An apparatus for wireless communication, comprising at least one means for performing the method of one or more of Aspects 1-57.

Aspect 61: A non-transitory computer-readable medium storing code for wireless communication, the code comprising instructions executable by a processor to perform the method of one or more of Aspects 1-57.

Aspect 62: A non-transitory computer-readable medium storing a set of instructions for wireless communication, the set of instructions comprising one or more instructions that, when executed by one or more processors of a device, cause the device to perform the method of one or more of Aspects 1-57.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
receive information indicating a sub-band full-duplex (SBFD) frequency configuration for a first sub-band of a carrier,
the information indicating that the first sub-band is an uplink sub-band or a downlink sub-band,
the information indicating at least one SBFD frequency configuration for a second sub-band of the carrier,
the information indicating one or more guard bands separating the first sub-band from the second sub-band, and
the frequency configuration being for at least one symbol that includes at least one uni-directional symbol; and
communicate with another device using the SBFD frequency configuration.

2. The UE of claim 1, wherein the one or more processors, to receive the information, are configured to:
receive the information via one or more information elements included in radio resource control cell common configuration communication from a network node.

3. The UE of claim 1, wherein the first sub-band is the uplink sub-band, the second sub-band is the downlink sub-band, and the at least one uni-directional symbol comprises at least one downlink symbol.

4. The UE of claim 1, wherein the first sub-band is the downlink sub-band, the second sub-band is the uplink sub-band, and the at least one uni-directional symbol comprises at least one uplink symbol.

5. The UE of claim 1, wherein the one or more processors are further configured to:
determine a frequency configuration for the one or more guard bands to include portions of the carrier that are not included in the first sub-band and the second sub-band.

6. The UE of claim 1, wherein the one or more processors are further configured to:
determine the at least one SBFD frequency configuration for the second sub-band to include portions of the carrier that are not included in the first sub-band and the one or more guard bands.

7. The UE of claim 1, wherein the information indicating the at least one SBFD frequency configuration for the second sub-band identifies a starting resource block and a length in resource blocks.

8. The UE of claim 1, wherein the information indicating the SBFD frequency configuration for the first sub-band includes a starting resource block, a length in resource blocks, and a resource block offset.

9. The UE of claim 9, wherein the one or more processors are further configured to:
determine the resource block offset with reference to one of:
a first resource block of the carrier, or
a preconfigured reference point.

10. The UE of claim 1, wherein the information indicating the SBFD frequency configuration includes a first timing configuration for the first sub-band.

11. The UE of claim 10, wherein the information indicating the SBFD frequency configuration includes a second timing configuration for the second sub-band.

12. The UE of claim 10, wherein the first timing configuration comprises information indicating a time offset, a length of time, and a periodicity.

13. The UE of claim 10, wherein a periodicity of the first timing configuration is based at least in part on a time domain duplexing pattern periodicity.

14. The UE of claim 10, wherein the first timing configuration indicate one or more SBFD symbol patterns.

15. The UE of claim 14, wherein the first timing configuration indicates multiple SBFD symbol patterns based at least in part on multiple time domain duplexing patterns being indicated.

16. The UE of claim 10, wherein the first timing configuration indicates first SBFD symbols associated with the first sub-band in at least one downlink symbol, and a second timing configuration indicates second SBFD symbols associated with the second sub-band in at least uplink symbol.

17. The UE of claim 10, wherein a subcarrier spacing associated with the first timing configuration is based at least in part on a time domain duplexing pattern.

18. A network node for wireless communication, comprising:
one or more memories; and
one or more processors, coupled to the one or more memories, configured to:
transmit information indicating a sub-band full-duplex (SBFD) frequency configuration for a first sub-band of a carrier,
the information indicating that the first sub-band is an uplink sub-band or a downlink sub-band,
the information indicating at least one SBFD frequency configuration for a second sub-band of the carrier,
the information indicating one or more guard bands separating the first sub-band from the second sub-band, and
the frequency configuration being for at least one symbol that includes at least one uni-directional symbol; and
communicate with another device using the SBFD frequency configuration.

19. The network node of claim 18, wherein the one or more processors, to transmit the information, are configured to:
transmit the information via one or more information elements included in radio resource control cell common configuration communication.

20. The network node of claim 18, wherein the first sub-band is the uplink sub-band, the second sub-band is the downlink sub-band, and the at least one uni-directional symbol comprises at least one downlink symbol.

21. The network node of claim 18, wherein the first sub-band is the downlink sub-band, the second sub-band is the uplink sub-band, and the at least one uni-directional symbol comprises at least one uplink symbol.

22. The network node of claim 18, wherein the one or more processors are further configured to:
determine a frequency configuration for the one or more guard bands to include portions of the carrier that are not included in the first sub-band and the second sub-band.

23. The network node of claim 18, wherein the one or more processors are further configured to:
determine the at least one SBFD frequency configuration for the second sub-band to include portions of the carrier that are not included in the first sub-band and the one or more guard bands.

24. The network node of claim 18, wherein the information indicating the at least one SBFD frequency configuration for the second sub-band identifies a starting resource block and a length in resource blocks.

25. The network node of claim 18, wherein the information indicating the SBFD frequency configuration for the first sub-band includes a starting resource block, a length in resource blocks, and a resource block offset.

26. The network node of claim 25, wherein the one or more processors are further configured to:
determine the resource block offset with reference to one of:
a first resource block of the carrier, or
a preconfigured reference point.

27. The network node of claim 25, wherein the first timing configuration comprises information indicating a time offset, a length of time, and a periodicity.

28. The network node of claim 18, wherein the information indicating the SBFD frequency configuration includes a first timing configuration for the first sub-band and a second timing configuration for the second sub-band.

29. A method of wireless communication performed by a user equipment (UE), comprising:
receiving information indicating a sub-band full-duplex (SBFD) frequency configuration for a first sub-band of a carrier,
the information indicating that the first sub-band is an uplink sub-band or a downlink sub-band,
the information indicating at least one SBFD frequency configuration for a second sub-band of the carrier,
the information indicating one or more guard bands separating the first sub-band from the second sub-band, and
the frequency configuration being for at least one symbol that includes at least one uni-directional symbol; and
communicating with another device using the SBFD frequency configuration.

30. A method of wireless communication performed by a network node, comprising:
transmitting information indicating a sub-band full-duplex (SBFD) frequency configuration for a first sub-band of a carrier,
the information indicating that the first sub-band is an uplink sub-band or a downlink sub-band,
the information indicating at least one SBFD frequency configuration for a second sub-band of the carrier,
the information indicating one or more guard bands separating the first sub-band from the second sub-band, and
the frequency configuration being for at least one symbol that includes at least one uni-directional symbol; and
communicating with another device using the SBFD frequency configuration.
